(19) United States
(12) Patent Application Publication
(10) Pub. No.: US 2026/0124604 A1
(43) Pub. Date: May 7, 2026

(54) METHOD FOR PREPARING A GENERALLY SPHERICAL CATALYST PRECURSOR MATERIAL FOR A METHANATION REACTION, SPHERES OBTAINED BY SUCH A METHOD, METHANATION METHOD AND DEVICE

(71) Applicants: ENGIE, Courbevoie (FR); ENERCAT - ALSYS GROUP, Ploemeur (FR)

(72) Inventors: Yilmaz KARA, Courbevoie (FR); Larissa BRITO; Arnaud LAHOUGUE

(21) Appl. No.: 18/876,205

(22) PCT Filed: Jul. 4, 2023
(86) PCT No.: PCT/EP2023/068440

§ 371 Date: Dec. 18, 2024

(30) Foreign Application Priority Data
Jul. 7, 2022 (FR) FR2206974

(51) Int. Cl. B01J 23/755; B01J 35/38; B01J 35/51; B01J 35/61; B01J 35/64; B01J 37/00; B01J 37/02; B01J 37/08

(52) U.S. Cl. CPC B01J 23/755; B01J 35/38; B01J 35/51; B01J 35/613; B01J 35/615; B01J 35/647; B01J 37/0045; B01J 37/0072; B01J 37/0201; B01J 37/08

(57) ABSTRACT

The preparation method (100) for preparing a generally spherical catalyst precursor material comprises:
a formation step (101) for forming a generally spherical support comprising mesoporous alumina (Al₂O₃) or an alumina precursor and having a sphericity factor greater than 0.75, preferably greater than 0.80 and more preferably greater than 0.85,
an incorporation step (102) for incorporating a nickel precursor into the support comprising mesoporous alumina (Al₂O₃) or an alumina precursor by bringing a composition comprising the nickel precursor into contact with the support and
a calcination step (103) for calcining the support incorporating the nickel precursor to at least partially transform the nickel precursor into nickel oxide (NiO) and the alumina precursor into alumina, and subsequently form a solid having a generally spherical shape, the solid being referred to as a “sphere made of a catalyst precursor material for a methanation reaction”.

### TECHNICAL FIELD OF THE INVENTION

The present invention relates to a method and a device for preparing a catalyst precursor material for a methanation reaction, a material obtained by such a method, and a method and a device for a methanation reaction. It applies, in particular, to the field of the conversion of carbon monoxide (CO) and/or carbon dioxide (CO₂), in a gas mixture rich in hydrogen, into a mixture rich in methane (CH₄), preferably using a fluidised-bed reactor.

### STATE OF THE ART

For the production of a mixture rich in methane (CH₄), from the conversion of carbon monoxide (CO) and/or carbon dioxide (CO₂) in a gas mixture rich in hydrogen, also called methanation reaction, there are reactors utilising heterogeneous catalysts for the methanation reaction. These heterogeneous catalysts are mainly made of catalytic materials based on nickel (Ni) supported on a support made of alumina (Al₂O₃). The reactors of the methanation reaction generally operate with a fixed catalytic bed or a fluidised catalytic bed.

In current systems, the catalytic materials used in fluidised catalytic bed methanation reactors do not have a good quality of fluidisation, and resistance to attrition is limited. In effect, during the implementation of a methanation reaction in a fluidised-bed reactor, the attrition of particles made of a catalytic material, also called degradation, takes place as a result of mechanical stresses inherent in the hydrodynamics of the fluidisation. In particular, the particles made of a catalytic material form fines following the attrition, which leads to a drop in catalytic performance. These mechanical stresses are due, for example, to mechanical impacts between the particles made of a catalytic material, between these particles and the inner wall of the reactor, or between these particles and elements present in the reactor, such elements being, for example, cooling tubes, chicanes, and/or supports. In practice, this attrition is also the result of the eradication of the angular shapes likely to be present on the catalytic particles.

### DESCRIPTION OF THE INVENTION

The present invention aims to remedy all or part of these drawbacks.

To this end, according to a first aspect, the present invention envisions a method for preparing a generally spherical catalyst precursor material for a methanation reaction according to claim 1.

Thanks to these provisions, the method makes it possible to obtain a generally spherical catalyst precursor material having a good quality of fluidisation combined with limited attrition. In particular, such a sphericity factor is dependent on the step forming the spherical support. In addition, these provisions also make it possible to obtain a catalyst precursor material on an industrial scale and having high sphericity.

Thanks to the mechanical treatment step, an increase in the sphericity of the catalyst material produced by such a method makes it possible to limit angular shapes for the catalytic particles. In this way, the attrition linked to the presence of angular shapes is limited during a fluidised-bed methanation reaction.

In some embodiments, the mechanical treatment step is performed in a fluidised bed by passing a gas in contact with the spherical support. Thanks to these provisions, the method makes it possible to improve the quality of the support by eliminating possible surface faults before the step incorporating the nickel precursor. In particular, the fluidised bed plays a role in the progressive removal of surface faults of the support. The fluidisation therefore performs a dynamic polishing of the surface of the catalyst. This optimises the sphericity of the support.

In some embodiments, the mechanical treatment step and calcination step are concurrent and preferably performed in a fluidised bed.

In some embodiments, during the mechanical treatment step performed in a fluidised bed, the gas in contact with the spherical support is an inert gas.

In some embodiments, during the mechanical treatment step performed in a fluidised bed the fluidisation rate is at least two times higher than the minimum fluidisation velocity.

In some embodiments, during the mechanical treatment step performed in a fluidised bed, preferably, the fluidisation rate is at least six times higher than the minimum fluidisation velocity.

In some embodiments, during the mechanical treatment step performed in a fluidised bed the fluidisation rate is at least ten times higher than the minimum fluidisation velocity.

In some embodiments, after the step of mechanical treatment in a fluidised bed, the step of incorporating a nickel precursor is also performed in the fluidised-bed reactor.

In some embodiments, the mechanical treatment step is performed using a rotating tank configured to generate impacts between the support particles.

In some embodiments, the generally spherical support comprises a hydrated alumina of boehmite type (formula AlOOH).

In some embodiments, the incorporation step comprises a step of impregnating the support with a solution comprising the nickel precursor. Thanks to these provisions, the method makes it possible to perform a simplified incorporation of the spherical support using an easily prepared nickel precursor solution.

In some embodiments, the step forming the spherical support comprises a granulation step.

In some embodiments, the step forming the spherical support comprises an atomisation step. Thanks to these provisions, the method makes it possible to control the size and sphericity factor of the spherical support and therefore of the sphere of catalyst precursor material.

In some embodiments, the step forming the spherical catalytic support comprises a step of droplet coagulation. Thanks to these provisions, the method makes it possible to control the size and sphericity factor of the spherical support and therefore of the sphere of catalyst precursor material. In addition, the equipment used to implement the method is smaller and the energy consumption is lower. In this way, the cost of implementing the method is reduced.

According to a second aspect, the invention envisions a device for preparing a generally spherical catalyst precursor material for a methanation reaction, which device comprises:
a means for forming a generally spherical support comprising mesoporous alumina (Al₂O₃) or an alumina precursor;
a means for incorporating a nickel precursor into the support comprising mesoporous alumina (Al₂O₃) or an alumina precursor, by bringing a composition comprising the nickel precursor into contact with the support;
a means for calcining the support incorporating the nickel precursor, configured to at least partially transform the nickel precursor into nickel oxide (NiO) and the alumina precursor into alumina, and configured to form a solid having a generally spherical shape, this solid being referred to as a “sphere made of a catalyst precursor material for a methanation reaction”; and a means for mechanically treating the spherical support, after the formation of the support, to increase the sphericity factor of the spherical support.

As the particular aims, advantages and features of the device that is the subject of the invention are similar to those of the method that is the subject of the invention, they are not repeated here.

According to a third aspect, the invention envisions spheres made of a catalyst precursor material for a methanation reaction, obtained by the method that is the subject of the invention, which spheres comprise nickel oxide (NiO) and mesoporous alumina (Al₂O₃), the respective proportions of which are, relative to the total mass of these two compounds:
NiO: 1 to 50% by mass; and
Al₂O₃: 50 to 99% by mass.

Thanks to these provisions, the spheres made of a catalyst precursor material, when they are activated and used in a fluidised-bed methanation reaction, have good hydrodynamic properties and high mechanical strength. This results in good fluidisation of the catalytic bed, limitation of the attrition of the spheres and a reduced production of fines. The catalytic activity of the metal incorporated into the spheres, during the fluidised-bed methanation reaction, is thus optimised. In addition, the increase in the mechanical strength makes it possible to extend the duration of use of the spheres in the fluidised-bed methanation reaction by reducing, in particular, the detachment of the active metallic species of the support.

In some embodiments, the spheres made of a catalyst precursor material have a monomodal granulometry with a median diameter of between 100 and 1000 μm, preferably between 200 and 800 μm, and more preferably between 250 and 350 μm. Thanks to these provisions, the monomodal granulometry of the spheres activated and used in a fluidised-bed methanation reaction enables an optimum fluidisation.

In some embodiments, the alumina (Al₂O₃) has a gamma or delta structure. Thanks to these provisions, the alumina of the spherical support has a structure especially suitable for implementing a catalyst for a methanation reaction.

In some embodiments, the alumina (Al₂O₃) has a mesoporosity corresponding to a median diameter of the pores, determined by Hg intrusion porosimetry, of between 3 and 50 nm, and preferably between 5 and 25 nm.

In some embodiments, the spheres made of a catalyst precursor material have a specific surface area of between 50 and 300 m²/g, and preferably between 100 and 250 m²/g.

According to a fourth aspect, the invention envisions a methanation method, which comprises:
a step of activating, at least partially, spheres made of a catalyst precursor material that are the subjects of the invention into spheres made of a catalytic material; and
a step of passing a gas comprising hydrogen (H₂) and at least carbon monoxide (CO) and/or carbon dioxide (CO₂) in contact with spheres made of a catalytic material.

Thanks to these provisions, the method enables the use of spheres made of a catalyst precursor material that are the subjects of the invention in a methanation reaction, after activation in spheres made of a catalytic material.

In some embodiments, the method comprises, prior to the gas passage step, a step of constituting the gas comprising at least one of the following steps:
pyrolysis of hydrocarbon materials;
pyro-gasification of hydrocarbon materials;
gasification of hydrocarbon materials;
co-electrolysis of CO₂/H₂O;
water-gas reaction;
reverse water-gas reaction;
a step of producing a gas rich in hydrogen;
a step of producing a gas rich in CO₂; and
a step of introducing vapour to the gas.

Thanks to these provisions, one can make use of a gas obtained during an intermediate step. In some embodiments, during the step of passing the gas in contact with spheres made of a catalytic material, the gas goes through a fluidised bed of spheres made of a catalytic material. Thanks to these provisions, the method enables the use of spheres made of a catalyst precursor material that are the subjects of the invention in a fluidised-bed methanation reaction, after activation in spheres made of a catalytic material. Note that the spheres used in the method have the same technical advantages with regard to fluidisation and mechanical strength mentioned previously.

According to a fifth aspect, this invention envisions a methanation device, characterised in that it comprises:
a layer of spheres made of a catalytic material, obtained by activating spheres made of a catalyst precursor material that are the subjects of the invention; and
a means for passing a gas comprising hydrogen (H₂) and at least carbon monoxide (CO) and/or carbon dioxide (CO₂) in contact with spheres made of a catalytic material.

As the particular aims, advantages and features of the device that is the subject of the invention are similar to those of the method that is the subject of the invention, they are not repeated here.

### BRIEF DESCRIPTION OF THE FIGURES

Other advantages, aims and particular features of the invention will become apparent from the non-limiting description that follows of at least one particular embodiment of the devices and methods that are the subjects of the invention, with reference to drawings included in an appendix, wherein:

FIG. 1 represents, in the form of a logical diagram, a first particular series of steps of the preparation method that is the subject of the invention;

FIG. 2 represents, in the form of a logical diagram, a second particular series of steps of the preparation method that is the subject of the invention;

FIG. 3 represents, in the form of a logical diagram, a third particular series of steps of the preparation method that is the subject of the invention;

FIG. 4 represents, in the form of a logical diagram, a fourth particular series of steps of the preparation method that is the subject of the invention;

FIG. 5 represents, schematically, a first particular embodiment of a preparation device that is the subject of the invention;

FIG. 6 represents, in the form of a logical diagram, a particular series of steps of the methanation method that is the subject of the invention;

FIG. 7 represents, schematically, a first particular embodiment of a methanation device that is the subject of the invention;

FIG. 8 represents, graphically, a study of fluidisation during the utilisation of spheres in a methanation reaction, corresponding to the conversion rate as a function of the flow rate;

FIG. 9 represents, graphically, a first study of attrition during the utilisation of spheres in conditions of attrition, corresponding to the rate of attrition as a function of time; and

FIG. 10 represents, graphically, a second study of attrition during the utilisation of spheres in conditions of attrition, corresponding to the cumulative mass as a function of time.

### DESCRIPTION OF THE EMBODIMENTS

The present description is given in a non-limiting way, in which each characteristic of an embodiment can be combined with any other characteristic of any other embodiment in an advantageous way.

The following definitions are noted here:

The term “support” refers to a single material, with no pre-catalyst or catalyst. For example, such a support comprises alumina (Al₂O₃).

The term “catalyst precursor material”, also called pre-catalyst, refers to an assembly formed by a support and a catalytic species in deactivated form, such as nickel oxide (formula NiO), incorporated into the support.

The terms “catalytic material” and “catalyst” refer to an assembly formed by the catalytic support and the metal phase incorporated into this support. In particular, the metal phase is in activated form, also called “active phase”, and corresponds to the metallic nickel (formula Ni(0)) obtained after reduction of the nickel oxide (NiO). Only the metallic nickel is active in the catalysis of a methanation reaction.

The terms “methanation reaction” or “methanation”, also called the Sabatier reaction, refer to a hydrogenation of the carbon monoxide (formula CO) and/or carbon dioxide (formula CO₂) to produce a gas containing methane (CH₄). Depending on the gaseous species, CO or CO₂, involved in the methanation reaction, the hydrogenation reaction equations R1 or R2 are according to the following chemical equations:

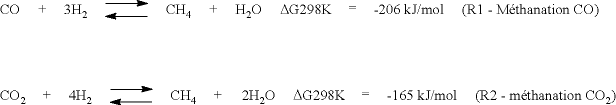

For example, such a methanation reaction is performed starting from a synthetic gas, also called “syngas”, preferably purified upstream from the methanation unit. It is noted that a synthetic gas is generally rich in CO, H₂, CO₂ and CH₄. A methanation reaction implemented starting from such a synthetic gas makes it possible to increase the proportion of methane in the gas. Note that methanation implemented in the presence of a catalyst is also called “catalyst methanation”.

The term “sphericity factor” refers to the ratio of the surface area of the sphere having the same volume as a defined particle to the surface area of said particle.

The term “incorporation” is similar to the term functionalisation, corresponding to the fixing of a species or a chemical function onto a support.

The term “monomodal granulometry” is a statistical term characterising the distribution of the sphere sizes.

The term “median diameter”, also called d50, is a statistical term characterising the size of the spheres. For example, a median diameter d50 equal to 150 μm means that 50% of the particles in the distribution have a size smaller than 150 μm and 50% of the particles in the distribution have a size greater than 150 μm. Similarly, the terms d90 and d10 are statistical terms characterising the size of the spheres. For example, a diameter d10 equal to 150 μm means that 10% of the particles in the distribution have a size smaller than 150 μm and 90% of the particles in the distribution have a size greater than 150 μm. For example, a diameter d90 equal to 150 μm means that 90% of the particles in the distribution have a size smaller than 150 μm and 10% of the particles in the distribution have a size greater than 150 μm.

The term “water-gas reaction” refers to a reaction producing hydrogen by a reaction between carbon monoxide (CO) and water (formula H₂O), also called “Water Gas Shift reaction” or “WGS” and the following chemical equation R3:

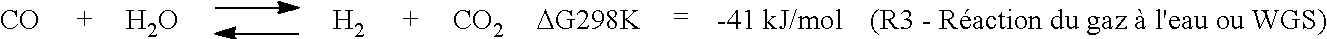

The term “reverse water-gas reaction” refers to the reverse reaction to the water-gas reaction described above. The term “specific surface area” is similar to an active surface area of the catalytic material corresponding to a surface area of a solid catalyst in contact with gaseous reagents, such as CO₂, CO and H₂.

The term “fluidised bed” refers to a mixture in which an assembly of particles and gas form a fluidised bed. Such particles are, in particular:
spheres made of a support;
spheres made of a catalyst precursor material, calcined or non-calcined; or
spheres made of a catalytic material.

Such a fluidised bed is, for example, utilised in a fluidised-bed reactor (acronym “FBR”).

The term “fines” refers to catalytic particles formed by the attrition of the catalytic material during the fluidised-bed methanation method. In particular, the formation of fines leads to a progressive modification in the fluidisation conditions of the fluidised bed. For example, this results in a loss of surface area of the catalyst and a change in the granulometry of the catalytic bed.

All the contents are, in the description, expressed as a percentage by mass for the solids, and the contents of the gases are expressed as a percentage by volume in dry gas.

Throughout the description, the term “upper” refers to being located at the top in the figures, which corresponds to the normal configurations of use of the devices, the term “bottom” to being located at the bottom in the figures, and the terms “vertical” and “horizontal” flow from these definitions.

It is now noted that the figures are not to scale.

### Method for Preparing a Catalyst Precursor Material for a Methanation Reaction

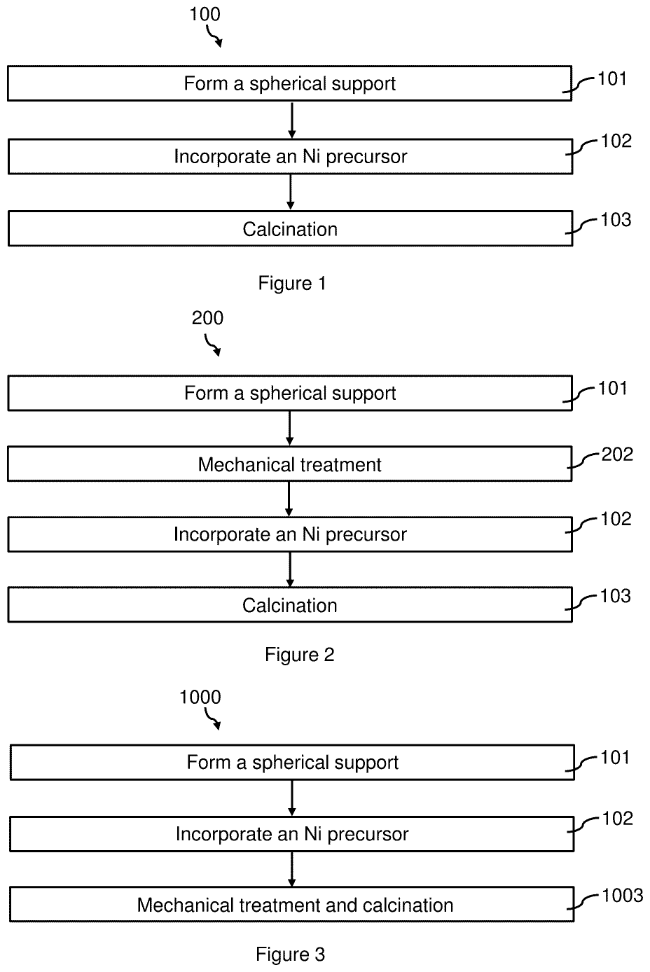

FIG. 1 shows, in the form of a logical diagram, an embodiment of the method 100 that is the subject of the invention. The method 100 for preparing a generally spherical catalyst precursor material for a methanation reaction, which method comprises:
a formation step 101 for forming a generally spherical support comprising mesoporous alumina (formula Al₂O₃) or an alumina precursor;
an incorporation step 102 for incorporating a nickel precursor into the support comprising mesoporous alumina (formula Al₂O₃) or an alumina precursor, by bringing a composition comprising the nickel precursor into contact with the support; and
a calcination step 103 for calcining the catalytic support incorporating the nickel precursor to at least partially transform the nickel precursor into nickel oxide (formula NiO) and the alumina precursor into alumina, and subsequently form a solid having a generally spherical shape, such a solid being referred to as a “sphere made of a catalyst precursor material for a methanation reaction”.

During the formation step 101, the support comprising mesoporous alumina (Al₂O₃) or the alumina precursor is formed. This formation consists of obtaining a generally spherical support having a sphericity factor greater than 0.75, preferably greater than 0.80 and more preferably greater than 0.85.

In some embodiments, the alumina precursor is a hydrated alumina of boehmite type (formula AlOOH).

In some embodiments, the formation step 101 for forming a generally spherical support is performed by granulation.

In other embodiments, the formation step 101 for forming a generally spherical support is performed by atomisation. The atomisation is applied, for example, to a suspension of boehmite (AlOOH) or alumina (Al₂O₃) in water. During the atomisation, the suspension is sprayed as fine droplets by means of an atomiser turbine, or by high pressure injection through nozzles, into a vertical cylindrical chamber swept by a flow of hot air. Evaporation of the water leads to the formation of a dry powder collected in the bottom portion of the equipment. Note that the atomisation parameters and the characteristics of the equipment used determine the granulometry of the particles.

In some embodiments (not shown), the step of forming a generally spherical support that is performed by atomisation also comprises an intermediate heat treatment step. Note that such an intermediate heat treatment step is performed to consolidate the support and thus give it good mechanical resilience. For example, such an intermediate heat treatment enables a decomposition of any binding agents, a loss of the constituent water, and potentially a crystalline phase change. In this way, a better cohesion between the grains of material is obtained.

In other embodiments, the step 101 of forming a spherical support is performed by droplet coagulation, also called “oil draining”. Preferably, the droplet coagulation is performed in two successive steps, the first step consisting of forming the drops and the second step consisting of gelifying the drops. For example, the drops of a suspension of boehmite (AlOOH) or alumina (Al₂O₃) in water are introduced into a column containing an upper phase comprised of petroleum and a lower aqueous phase comprised of an ammonia solution. The forming occurs in the upper phase and the gelling in the lower phase. Preferably, the ammonia solution has its pH maintained at a value above approximately 9. The retention time of the drops in the ammonia is several minutes and generally less than approximately 15 minutes.

During the incorporation step 102, the support comprising mesoporous alumina (Al₂O₃) or an alumina precursor is brought into contact with a composition comprising the nickel precursor. This bringing into contact makes it possible to form a material incorporating a nickel precursor supported on the support. In some embodiments, the incorporation step 102 is a step of impregnating the support with a solution comprising the nickel precursor. Preferably, the nickel precursor is a nickel salt, for example nickel (II) nitrate hexahydrate, formula Ni(NO₃)₂·6H₂O. Such an impregnation can be performed:
“dry”, acronym “IWI” (for “Incipient Wetness Impregnation”), the volume of the solution comprising the prepared nickel precursor is therefore less than or equal to the volume that can be absorbed by the support; or
by excess solvent, or “wet”, the volume of the solution comprising the prepared nickel precursor is therefore greater than the volume that can be absorbed by the support.

In some embodiments, when the incorporation step is an impregnation step, the impregnation step is performed two times in succession.

In some variants, the formation step 101 and the incorporation step 102 are concurrent. Such a method makes it possible to obtain in a single step a spherical catalyst precursor material, referred to as “intermediate”. In this way, the method is simplified and therefore can be adapted according to the industrial constraints present in the production unit.

In some embodiments, when the incorporation step 101 and impregnation step 102 are concurrent, the granulation, atomisation or droplet coagulation steps are performed by incorporating a solution comprising a nickel salt to a suspension of an alumina precursor, for example boehmite (AlOOH), or alumina (Al₂O₃). Preferably, the nickel precursor is a nickel salt, for example nickel (II) nitrate hexahydrate, formula Ni(NO₃)₂·6H₂O.

During the calcination step 103, heat treatment of the spherical support incorporating the nickel precursor is performed. The calcination step 103 makes it possible to transform, at least partially:
the nickel precursor into nickel oxide (NiO); and
the alumina precursor, such as hydrated alumina of boehmite type (AlOOH), into alumina (Al₂O₃).

In this way, a sphere made of a catalyst precursor material for a methanation reaction is obtained at the end of this calcination step.

In some embodiments, the calcination step (103) is performed at a temperature of between 30° and 500° C., preferably between 38° and 420° C. and more preferably approximately equal to 400° C. In some embodiments, the calcination step 103 is performed in an atmosphere comprising oxygen, for example in air or oxygen. In some embodiments, the duration of calcination of the calcination step 103 is greater than 2 hours, and preferably approximately equal to 4 hours.

Note that, in these embodiments, the steps performed after the formation step 101, such as the incorporation step 102 and calcination step 103, have a limited impact on the sphericity factor of the sphere of catalyst precursor material. In other words, the final sphericity factor is mainly determined by the formation step 101.

In some embodiments, such as that shown in FIG. 2, the method 200 comprises a step 202 of mechanically treating the spherical support after the step 101 for forming the support. During the mechanical treatment step 202, the spherical support obtained after the formation step 101 is subject to mechanical stresses. For example, the support that has been mechanically treated has a sphericity factor greater than 0.85. Preferably, the sphericity factor is greater than 0.9.

Note that, during the step 202 of mechanically treating the support, possible surface faults are eliminated. In this way, the quality of the support is improved, prior, for example, to the step 102 of incorporating the nickel precursor. In addition, the sphericity factor of the spherical support is higher than the sphericity factor of the support obtained after the formation step 101. In other words, the mechanical treatment step 202 is performed so as to increase the sphericity factor of the spherical support. In particular, the elimination of certain surface faults on the support limits the generation of fines, which fines may be generated during attrition phenomena. Preferably, the incorporation step 102 is positioned downstream from the mechanical treatment step 202.

In some embodiments, the mechanical treatment step 202 is performed in a fluidised bed by passing a gas in contact with the spherical support. The mechanical treatment step 202 performed by fluidisation of the single support makes it possible to “de-fine”, i.e. form fines by attrition, and improve the surface condition of the support.

In some variants, the mechanical treatment step 202 is performed using a rotating tank configured to generate impacts between the support particles and therefore surface attrition, resulting in an improvement in the sphericity of the support.

Preferably, such a mechanical treatment step 202 is performed prior to the nickel precursor incorporation 102. Note that such a mechanical treatment step 202 in a fluidised bed or in a rotating tank is performed to reduce active phase losses of the catalytic material during the methanation reaction. The term “active phase” refers to the metal incorporated into the support. This step 202 of mechanically treating the support in a fluidised bed makes it possible, in particular, to anticipate the formation of fines that can take place during the fluidised-bed methanation reaction.

In some embodiments, during the step 202 of mechanical treatment performed in a fluidised bed, the gas in contact with the spherical support is an inert gas. In other words, the fluidisation is implemented under an inert gas. For example, the inert gas comprises air or nitrogen (formula N₂). Preferably, the fluidisation rate is two times higher than the minimum fluidisation velocity, more preferably six times higher than the minimum fluidisation velocity, and even more preferably ten times higher than the minimum fluidisation velocity.

In some embodiments, after the step 202 of mechanical treatment in a fluidised bed, the step 102 of incorporating a nickel precursor is also performed in the fluidised-bed reactor. Preferably, the incorporation step 102 comprises an impregnation step. More preferably, the incorporation step 102 comprises a dry impregnation step.

In some embodiments, after the incorporation step 102 performed in the fluidised-bed reactor, the calcination step 103 is also implemented in such a reactor. Preferably, during such a calcination step 103, the support is swept by hot air in the fluidised-bed reactor. Note that the calcination temperatures mentioned previously can be applied to this embodiment.

Preferably, in these embodiments, the gas coming from the calcination step 103 then undergoes treatment to reduce the NOx produced, such as a catalytic treatment or treatment by absorption, for example by washing in a scrubber.

In some embodiments, such as that shown in FIG. 3, in the method 1000, the mechanical treatment step 202 and the calcination step 103 are performed concurrently and preferably in a fluidised bed. In other words, in these embodiments, the method comprises the following successive steps:
a formation step 101;
an incorporation step 102; and
a joint step 1003 in which a mechanical treatment step 202 is performed at the same time as a calcination step 103.

Preferably, in these embodiments, the gas coming from the joint step 1003 then undergoes treatment to reduce the NOx produced.

Note that, in these embodiments, the mechanical treatment step is indirectly downstream from the formation step 101.

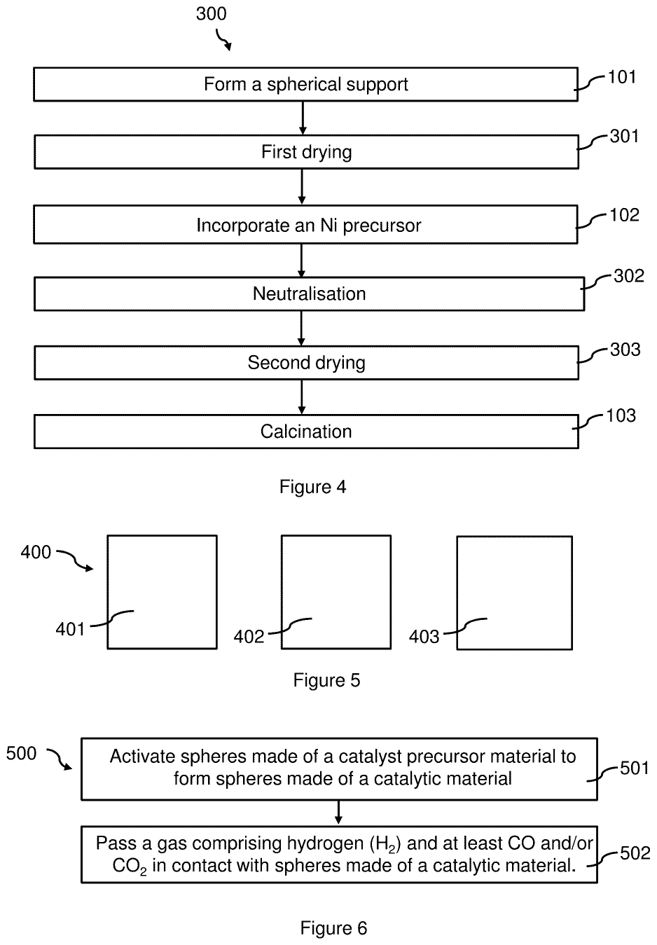

In some embodiments, such as that shown in FIG. 4, the method 300 comprises, in addition to the steps of formation 101, incorporation 102 and calcination 103, the following additional steps:
a first drying step 301 positioned downstream from the formation step 101 and upstream from the incorporation step 102;
a neutralisation step 302 positioned downstream from the incorporation step 102; and
a second drying step 303 positioned downstream from the neutralisation step 302 and upstream from the calcination step 103.

In some embodiments, the first drying step 301 is performed at a temperature of between 60° C. and 150° C. Preferably, the drying temperature is approximately equal to 80° C.

In some embodiments, the drying time of the first drying step 301 is greater than 10 hours. Note that the neutralisation step reduces, in particular, the formation of nitrogen oxides, also known as “Nox”. In some embodiments, the neutralisation step 302 is performed by using a neutralising solution, for example an ammonium carbonate solution, formula (NH₄)₂CO₃, and having a pH between 10 and 13. Preferably, the pH of the neutralising solution is approximately equal to 11.

In some embodiments, during the neutralisation step 302, the final pH of the solution comprising the spherical support incorporating the nickel precursor is between 6 and 8.

In some embodiments, the second drying step 303 is performed at a temperature of between 100° C. and 150° C., and preferably approximately equal to 125° C.

Device for preparing a catalyst precursor material for a methanation reaction preferably in a fluidised bed FIG. 5 shows a schematic view of an embodiment of the device 400 that is the subject of the invention. The device 400 for preparing a spherical catalyst precursor material for a methanation reaction, which device comprises:
a means 401 for forming a spherical support comprising mesoporous alumina (Al₂O₃) or an alumina precursor and having a sphericity factor greater than 0.75, preferably greater than 0.80 and more preferably greater than 0.85;
a means 402 for incorporating a nickel precursor into the support comprising mesoporous alumina (Al₂O₃) or an alumina precursor, by bringing a composition comprising the nickel precursor into contact with the support; and
a means 403 for calcining the support incorporating the nickel precursor, configured to at least partially transform the nickel precursor into nickel oxide (NiO) and the alumina precursor into alumina, and configured to form a solid having a generally spherical shape, this solid being referred to as a “sphere made of a catalyst precursor material for a methanation reaction”.

In some embodiments (not shown), the device also comprises a means for mechanically treating the spherical support configured to increase the sphericity factor of the support. In some embodiments, the mechanical treatment means comprises a fluidised bed during the mechanical treatment of the support. For example, the mechanical treatment means is a fluidised-bed reactor. In some embodiments, when a fluidised bed is utilised, the fluidisation rate is two times higher than the minimum fluidisation velocity. Preferably, the fluidisation rate is six times higher than the minimum fluidisation velocity, and even more preferably ten times higher than the minimum fluidisation velocity. Note that the means for mechanically treating the support obtained by the formation means 401 is configured to increase the sphericity factor of the support. Preferably, such an increase is carried out prior to the utilisation of the means 402 for incorporating the nickel precursor.

In some embodiments, the mechanical treatment means and the calcination means 403 are combined. For example, the mechanical treatment means comprises a fluidised bed having conditions allowing the calcination of the spherical support. For example, such conditions correspond to a calcination temperature. In some embodiments, the mechanical treatment means comprises, for example, a rotating tank configured to generate impacts between the support particles and therefore surface attrition, resulting in an improvement in the sphericity of the support.

Preferably, the means of the device 400 and the associated variants are configured to implement the steps of the methods, 100, 200, 300 and/or 1000, and their embodiments as described above, and the methods, 100, 200, 300 and/or 1000, and their different embodiments can be implemented by the means of the device 400.

### Spheres Made of a Catalyst Precursor Material for a Methanation Reaction Preferably in a Fluidised Bed

The spheres made of a catalyst precursor material for a methanation reaction that is the subject of the invention are obtained from an embodiment of the method that is the subject of the invention described above. The spheres made of a catalyst precursor material for a methanation reaction, preferably in a fluidised bed, comprise nickel oxide (NiO) and mesoporous alumina (Al₂O₃), the respective proportions of which are, relative to the total mass of these two compounds:
NiO: 1 to 50% by mass, preferably 10 to 50% by mass, and, even more preferably, 10 to 25% by mass; and
Al₂O₃: 50 to 99% by mass, preferably 50 to 90% by mass, and, even more preferably, 75 to 90% by mass.

In some embodiments, the alumina (Al₂O₃) is mesoporous and has a gamma or delta structure. In some embodiments, the mesoporous alumina (Al₂O₃) has a mesoporosity corresponding to a median diameter of the pores, determined by Hg intrusion porosimetry, of between 3 and 50 nm, and preferably between 5 and 25 nm.

In some embodiments, the spheres made of a catalyst precursor material for a methanation reaction also comprise a compound configured to trap catalyst poisons. Preferably, such a compound is a sacrificial catalyst or a specific poison scavenger. Such a compound is, for example, chosen from amongst oxides of zinc, molybdenum and tungsten.

In this way, the resistance of the spheres made of a catalytic material against organic or inorganic poisons, such as light tars (Benzene/Toluene/Xylenes, or BTX) or sulphur compounds, e.g. H₂S or COS), is increased.

In some embodiments, the spheres made of a catalyst precursor material have a pore volume, measured by Hg intrusion porosimetry, between 0.20 and 0.60 cm³/g and preferably between 0.25 and 0.40 cm³/g.

In some embodiments, the spheres made of a catalyst precursor material have a specific surface area of between 50 and 300 m²/g, and preferably between 100 and 250 m²/g.

In some embodiments, the spheres made of a catalyst precursor material have a monomodal granulometry with a median diameter of between 100 and 1000 μm (micrometre). Preferably, the median diameter of the spheres made of a catalyst precursor material is between 200 and 800 μm. Even more preferably, the median diameter of the spheres made of a catalyst precursor material is between 250 and 350 μm.

In some embodiments, during the use of spheres made of a catalytic material in a fluidised-bed methanation reaction, the particle size range is chosen, for example, according to a hydrodynamic condition and arrangement of the heat transfer surfaces. The hydrodynamic condition is, for example, defined by a fluidisation rate. In particular, during a large increase in the quantity of the synthesis gas involved in the methanation reaction, the granulometry of the catalyst is adjusted during the design, making it possible to avoid using a reactor with too large a diameter. Note that, in this example, such an adjustment is, in particular, also accompanied by an adjustment to the height of the catalytic layer used initially. This adjustment is necessary because of the exothermicity of a methanation reaction resulting in significant thermal power being released.

In some embodiments, the spheres made of a catalyst precursor material have a particle size distribution range, calculated using the ratio (d90-d10)/d50, less than 100%, preferably less than 70%, more preferably less than 50%, and even more preferably less than 20%.

In some embodiments, the spheres made of a catalyst precursor material have a particle size distribution range, calculated using the ratio (d90-d10)/d50, between 40% and 70%. In some variants, the particle size distribution range, calculated using the ratio (d90-d10)/d50, is between 60% and 70%.

In some variants, the spheres made of a catalyst precursor material have a polymodal granulometry. The term “polymodal granulometry” refers to a polymodal distribution, a term used in statistics, characterising the particle size distribution.

### Methanation Method

FIG. 6 shows, in the form of a logical diagram, an embodiment of the method 500 that is the subject of the invention. The methanation method 500 comprises:
a step 501 of activating, at least partially, spheres made of a catalyst precursor material into spheres made of a catalytic material having the same characteristics as the spheres made of a catalyst precursor material described above; and
a step 502 of passing a gas comprising hydrogen (H₂) and at least carbon monoxide (CO) and/or carbon dioxide (CO₂) in contact with spheres made of a catalytic material.

Note that the spheres made of a catalyst precursor material are obtained from the method for preparing a catalyst precursor material, the subject of the invention and described above. The characteristics of the spheres made of a catalyst precursor material that are the subject of the invention are identical to the characteristics of the spheres used in the methanation method.

During the activation step 501, the spheres made of a catalyst precursor material are activated at least partially into spheres made of a catalytic material, following a suitable temperature profile, in contact with a reducing agent. Preferably, the reducing agent is a reducing gas, such as, for example:
carbon monoxide (formula CO);
hydrogen (formula H₂);
ammonia (formula NH₃), or a mixture of at least two of these gases.

In some embodiments, the reducing gas is pure or diluted with an inert gas such as, for example, argon (formula Ar), nitrogen (formula N₂) or helium (formula He).

This activation step makes it possible to transform all or part of the nickel oxide (formula NiO) into metallic nickel (formula Ni(0)) and to provide all or part of the activation energy by hydrogenation of the CO₂, which is exothermic. The Ni(0) is the active catalytic species during the catalysis of the methanation reaction.

In some embodiments, the reducing gas is pure or diluted with carbon dioxide (formula CO₂) in addition to an inert gas such as, for example, argon (formula Ar), nitrogen (formula N₂) or helium (formula He).

In some embodiments, the suitable temperature profile for carrying out the activation step 501 comprises an increase in the ambient temperature to 400° C. with a temperature increase rate of 2° C./min, and a four-hour plateau at 400° C. in the presence of a reducing gas. Preferably, the activation step 501 is performed at a temperature of between 30° and 500° C., and even more preferably between 38° and 420° C. Preferably, the reducing gas comprises hydrogen (H₂), even more preferably associated with carbon dioxide (CO₂). Preferably, the activation step 501 is performed during a four-hour plateau.

During the passage step 502, a gas comprising hydrogen (H₂) and at least carbon monoxide (CO) and/or carbon dioxide (CO₂) is brought into contact with spheres made of a catalytic material. During the passage step 502, depending on the gaseous species CO or CO₂ present in the gas, the reactions R1 or R2 defined above take place. The passage of the gas thus enables the production of methane (CH₄) by hydrogenation of the CO and/or CO₂ in the presence of H₂.

In some variants, the activation step 501 is finished in a flow of syngas, followed by the step 502 of passing a gas comprising hydrogen (H₂) and carbon monoxide (CO).

In some variants, the activation step 501 is finished by a gas comprising hydrogen (H₂) and carbon dioxide (CO₂) followed by the passage step 502.

In some embodiments (not shown), the method 500 also comprises, prior to the gas passage step, a step of constituting the gas comprising at least one of the following steps:
pyrolysis of hydrocarbon materials (biomass, waste, carbon);
pyro-gasification of hydrocarbon materials (biomass, waste, carbon);
gasification of hydrocarbon materials (biomass, waste, carbon);
co-electrolysis of CO₂/H₂O as described in patent application EP 16757688.3, included here as reference;
water-gas reaction;
reverse water-gas reaction, described above;
electrolysis of the water;
a step of producing a gas rich in hydrogen;
a step of producing a gas rich in CO₂; and
a step of introducing vapour.

For example, the hydrogen produced during the step of producing a gas rich in hydrogen corresponds to an effluent to be treated. In particular, such an effluent comes from an associated method wherein the hydrogen constitutes a secondary product to be treated. Therefore, the methanation method, combined with the associated method producing a gas rich in hydrogen, enables the treatment, and therefore the reuse of such a gas. In other words, the hydrogen coming from the associated method is a source referred to as “unavoidable” for the methanation method. This example can also be transposed to CO₂ corresponding to a flow of effluents to be treated and produced during the step of producing a gas rich in CO₂ implemented in an associated method.

Note that a “gas rich in hydrogen” is a gas having a hydrogen molar percentage, relative to the total quantity of the gas, greater than 50%. Note that a “gas rich in CO₂” is a gas having a CO₂ molar percentage, relative to the total quantity of the gas, greater than 50%.

In some embodiments, during the step 502 of passing the gas in contact with spheres made of a catalytic material, the gas goes through spheres made of a catalytic material. In other embodiments, during the step 502 of passing the gas in contact with spheres made of a catalytic material, the gas goes through a fluidised bed of spheres made of a catalytic material.

Note that a fluidised bed enables a category of solids, here spheres made of a catalytic material, to be given certain properties of liquid fluids. In other words, in the case of the invention, a fluidised bed corresponds to the assembly formed by the spheres made of a catalytic material and the gas comprising H₂ and at least CO and/or CO₂. A fluidised bed enables a strong interaction between the spheres made of a catalytic material and the gas traversing it. The principle of the fluidised bed is to inject a pressurised gas under a layer of solid spheres made of a catalytic material. This gas lifts and disperses the solid spheres made of a catalytic material. The fluidised bed enables more effective catalysts.

The particle agitation and hydrodynamic mixing by flows of gaseous bubbles make the fluidised layers volumes in which the solid spheres made of a catalytic material are vigorously agitated. Within the fluidised bed, the spheres made of a catalytic material exchange heat and material very effectively, by direct contact, on a large specific surface area, with the gas or with an immersed heat exchanger with a view to reusing or removing the heat produced by the conversion reaction of CO and/or CO₂ into methane. The fluidised layer therefore constitutes an open volume, practically isothermal, because of the high specific heat capacity by mass of the solids compared to that of the gas, and by their renewal on contact with the exchange surfaces.

In some embodiments (not shown), the method 500 also comprises a step of cooling the fluidised bed by at least one heat exchange tube immersed in the fluidised bed. Preferably, the step 502 of passing the gas in contact with spheres made of a catalytic material and the step of cooling the fluidised bed are concurrent.

### Methanation Device

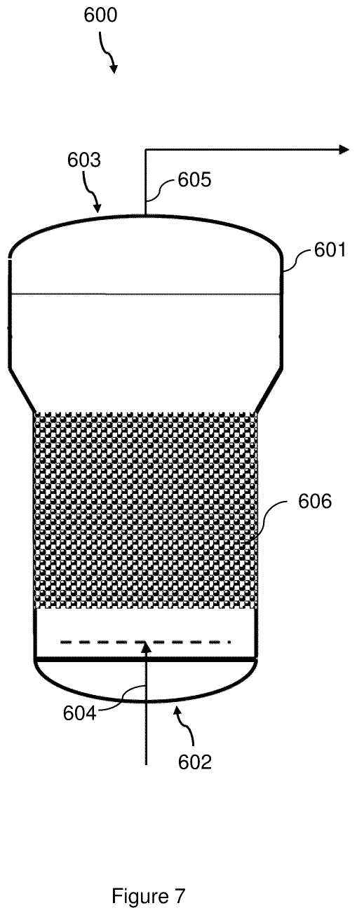

FIG. 7 shows a schematic view of an embodiment of the device 600 that is the subject of the invention. The methanation device 600 comprises:
a layer 606 of spheres made of a catalytic material, obtained by activating spheres made of a catalyst precursor material; and
a means 604 for passing a gas comprising hydrogen (H₂) and at least carbon monoxide (CO) and/or carbon dioxide (CO₂) on the layer of spheres made of a catalytic material.

Note that the spheres made of a catalyst precursor material are obtained from the method for preparing a catalyst precursor material, the subject of the invention. Preferably, such spheres are obtained from the method described above. The characteristics of the spheres made of a catalyst precursor material that are the subject of the invention are identical to the characteristics of the spheres used in the device 600.

Preferably, the means of the device 600 are configured to implement the steps of the method 500 and their embodiments as described above, and the method 500 and its different embodiments can be implemented by the means of the device 600.

Note that, in FIG. 7, the device 600 is configured to convert a gas comprising H₂ and at least CO and/or CO₂ into CH₄, during the passage of this gas over the spheres made of a catalytic material.

In some embodiments, such as that shown in FIG. 7, the reactor 600 comprises a chamber 601 having one lower longitudinal extremity 602 and one upper longitudinal extremity 603, opposite the lower longitudinal extremity 602. The chamber 601 is, for example, formed of a closed, sealed volume. The internal and/or external shape of the chamber 601 is not important for the invention, provided the chamber is sealed. For example, the chamber 601 has a tubular shape, i.e. a cylindrical shape, which can be oblong as shown in FIG. 7.

FIG. 7 shows that the chamber 601 comprises, near the lower extremity 602, an inlet 604 of gas comprising H₂ and at least CO and/or CO₂. The chamber 601 comprises, near the upper extremity 603, an outlet 605 for CH₄ or for a gas rich in CH₄. For example, the inlet 604 is an injection nozzle, a nozzle, a perforated tube, a perforated plate, a porous plate (sintered metal or porous ceramic), a network of porous sleeves, a network of piping equipped with strainers. However, any fluid injector usually used in a reactor can be used to realise the inlet 604. For example, the outlet 115 is an opening formed in the chamber 601 connected to a methane transport line.

In some embodiments, such as that shown in FIG. 7, the circulating gas coming from the inlet 604 passes through a layer of spheres made of a catalytic material present in the reactor 600. Preferably, the reactor 600 is a fluidised-bed reactor containing the spheres made of a catalytic material.

In some embodiments, the reactor 600 comprises heat exchange tubes (not shown) immersed in the fluidised bed of the chamber 601 and having a temperature compatible with the nominal operating temperature inside the chamber 601 during the operation of the reactor 600. The heat exchange tubes contain a circulating fluid having a lower temperature than the interior of the chamber 601. The heat exchange tubes thus enable the temperature of the reactor 600 to be maintained by removing excess heat linked the exothermicity of the reactions implemented. Preferably, this removed excess heat is reused.

The exothermicity of the methanation reactions, indicated in formula 1, results in a rise in the temperature of the reaction medium. In some embodiments, the average temperature of the reaction medium 606 is controlled and comprised between 260° C. and 350° C. This control of the average temperature of the reaction medium 606 boosts the activation and thermodynamics of the methanation reaction. This increases the reaction yield.

In some embodiments, the pressure inside the chamber 601 is between one bar (atmospheric pressure) and 70 bar. Preferably, the pressure is between 1 bar and 20 bar, more preferably between 1 bar and 14 bar, and even more preferably between 2 and 5 bar. These pressures optimize the conversion into methane by minimising the upstream compression costs.

In some embodiments, the fluidisation/flow rate range is between one and sixteen times the minimum fluidisation velocity, preferably between two and eight times the minimum fluidisation velocity. The heat exchange is therefore optimised. In particular, such a range corresponds to a preferred region for:
facilitating the heat exchange; and
reducing the mechanical stresses on the catalyst, such as attrition, and therefore reducing the elutriation of the catalyst.

### Examples of the Preparation of the Spherical Catalyst Precursor Material

Examples of the preparation of the spherical catalyst are mentioned in the following description, in a non-limiting way.

In a first example, a step 101 of forming a spherical support, also called “forming the support”, comprises an atomisation step. Such an atomisation step is implemented in an atomiser equipped with a bi-fluid nozzle and corresponds to the atomisation of a dispersion comprising:
50% by mass of a hydrated alumina of boehmite type;
50% by mass of a 2% acetic acid solution supplemented by 5% by mass of a temporary binder such as polyvinyl alcohol.

In this example, the input temperature of the atomiser is approximately equal to 400° C. and the output temperature maintained at approximately 140° C. In this way, a spray-dried powder having a residual humidity of approximately 10.2% is obtained.

In this example, the step 101 forming the spherical support can comprise, after the atomisation step, an intermediate heat treatment step corresponding, in particular, to calcination of the support at approximately 500° C. during 4 hrs. Note that such an intermediate heat treatment step is preferably performed in order to give the support good mechanical resilience.

Alternatively, in this example, a step 301 of drying at 80° C. for 12 hours in an oven can be performed after the step 101 of forming the spherical support without intermediate calcination, and in particular after the atomisation step.

Next, in this example, a step 102 of incorporating a nickel precursor, comprising a step of impregnation in excess solvent is implemented. This impregnation step is performed by immersing the spherical support made of alumina in an aqueous solution of nickel (II) nitrate hexahydrate, formula Ni(NO₃)₂·6H₂O, with a nickel concentration by mass equal to 17.5% at 60° C. for 1 hr.

Next, a neutralisation step 302 is carried out, by gradually adding to the solution containing the impregnated spherical support, an ammonium carbonate solution, formula (NH₄)₂CO₃, with pH equal to 11 and at 60° C. Note that the atomic ratio (NH₄)₂CO₃/Ni is equal to 1.75 and the volume of solution added covers the support. The pH of the final solution is approximately equal to 6.5. The final solution is eliminated and the support is washed with water with stirring. Preferably, the impregnation step is performed again.

Next, in this example, the impregnated and neutralised spherical support is dried at 125° C. in air for 12 hrs during a second drying step 303.

Next, in this first example, a calcination step 103 is carried out by putting the spherical support into a calciner at a temperature of 400° C. in air, with a temperature increase rate of between 1° C./min and 10° C./min, for 4 hrs.

In a second example, after the atomisation step mentioned above in the first example, a mechanical treatment step 202 is performed preferably in a fluidised bed. In particular, the support obtained after the formation step 101 is loaded into a fluidised-bed reactor. Next, in the reactor, the fluidisation is obtained by passing an inert gas, such as air and/or nitrogen, in contact with the spherical support. For example, the mechanical treatment step 202, preferably performed in a fluidised bed, is applied by implementing the following fluidisation conditions for 3 hrs:
gas: air;
temperature: 320° C.;
pressure: atmospheric;
fluidisation gas velocity 10 times higher than the minimum fluidisation velocity.

Such a mechanical treatment step 202 is implemented to improve the quality of the support and, in particular, increase the sphericity factor.

Next, in this second example, a step 102 of incorporating a nickel precursor comprising a dry impregnation step is performed in the reactor.

Lastly, in this second example, a calcination step 103 is implemented in the reactor by passing a flow of hot air in contact with impregnated spheres.

In a third example, after:
the atomisation step mentioned above in the first example; and
an impregnation step, preferably dry or wet impregnation,
a mechanical treatment step 202, concurrent with a calcination step 103, is performed, preferably in a fluidised bed.

In particular, the support obtained after the impregnation step is loaded into a reactor, preferably a fluidised-bed reactor. Next, in the reactor, the fluidisation is obtained by passing an inert gas, such as air and/or nitrogen and/or combustion fumes, in contact with the spherical support. For example, the mechanical treatment step 202, concurrent with a calcination step 103, preferably performed in a fluidised bed, is applied by implementing the following fluidisation conditions for 3 hrs:
gas: fumes;
temperature: 500° C.;
pressure: atmospheric;
fluidisation gas velocity 10 times higher than the minimum fluidisation velocity.

Such a mechanical treatment step 202, concurrent with a calcination step 103, is implemented to improve the quality of the support and, in particular, increase the sphericity factor while incorporating the nickel precursor. In this way, a sphere made of a catalyst precursor material for a methanation reaction is obtained at the end of this concurrent mechanical treatment and calcination step.

Examples of the implementation of spheres made of a catalyst precursor material and spheres made of a catalytic material during a fluidised-bed methanation reaction.

### Good Quality of Fluidisation.

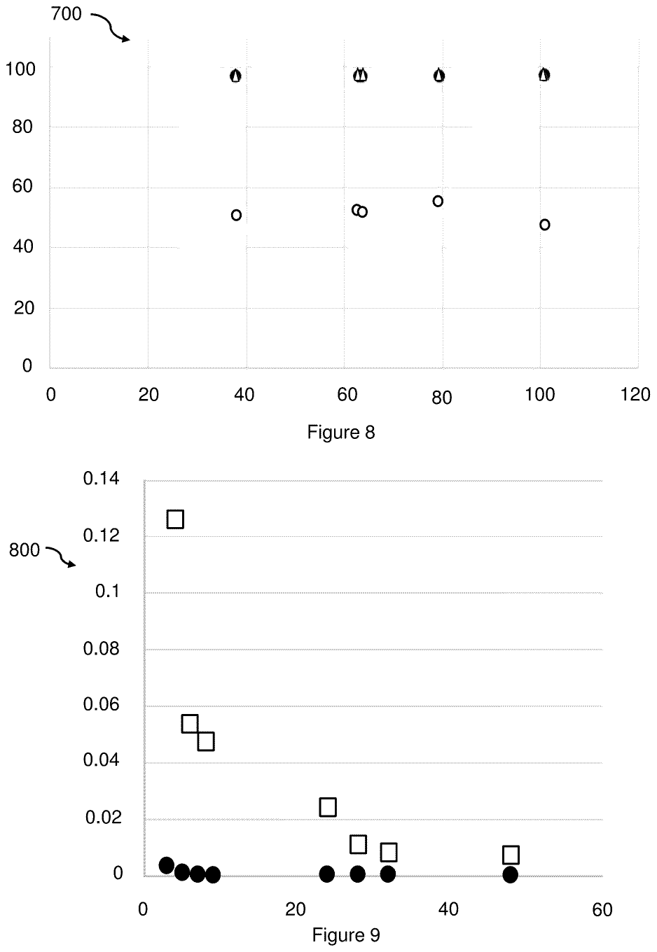

The spheres made of a catalytic material, obtained after activation of spheres made of a catalyst precursor material that are the subjects of the invention, were used during the implementation of a fluidised-bed methanation method. Note that FIG. 8 shows results obtained during the implementation of a methanation method.

In the examples of FIG. 8, the spheres made of a catalyst precursor material before the activation step have the following composition: 23.3% NiO, 76.7% Al₂O₃, and a sphericity factor equal to 0.79. Note that, in these examples, the spheres made of a catalyst precursor material are obtained, beforehand, by reducing treatment of the spheres made of a catalyst precursor material, the subject of the invention. This treatment is performed in a gaseous flow comprising hydrogen diluted in a flow of nitrogen according to an isovolumetric proportion, at a temperature of 400° C. for less than 10 hrs. The molar ratio of the hydrogen (H₂) and nickel is equal to 10. The velocity of the gas is 6 times higher than the minimum fluidisation velocity.

Note that, in these examples, the methanation reaction corresponds to the conversion of CO₂ into CH₄ in the presence of H₂ and is performed under the following conditions:
temperature equal to 325° C.;
pressure equal to 2 bara; and
composition of the gas before methanation, as a molar percentage relative to the total quantity of the gas: 30% CO₂ and 70% H₂.

Note that, for each of the examples in FIG. 8, different gas flow rates are applied in the conditions mentioned above. In particular, these different flow rates correspond to different fluidisation regimes. A methanation system is therefore obtained for each example.

Graph 700, shown in FIG. 8, presents, on the x-axis, the gas flow rate of the fluidised bed as Nm³/h and, on the y-axis, the conversion rate as a percentage. Note that several conversion rates are shown as a function of the gas flow rate:
the hydrogen (H₂) conversion rate, shown as a black circle;
the maximum H₂ conversion rate at equilibrium, shown as a white triangle;
the carbon dioxide (CO₂) conversion rate, shown as a white circle.

It can be seen, in FIG. 8, that the H₂ conversion rate and the maximum H₂ conversion rate at equilibrium are superposed. Note that the conversion rates indicated in FIG. 8 are defined by the following ratios:

The conversion of CO₂ is calculated, for example, according to the following equation:

$$Conversion {CO}_{2} = \frac{{Q}_{CO 2 , entrèe} - {Q}_{CO 2 , sortie}}{{Q}_{CO 2 , entrèe}} * 100 \%$$

where:
Q_{CO2.entrée} is the molar flow rate of CO₂ on input to the methanation reactor; and
Q_{CO2.sortie} is the molar flow rate of CO₂ on output from the methanation reactor.

The conversion of H₂ is calculated, for example, according to the following equation:

$$Conversion {H}_{2} = \frac{{Q}_{H 2 , entrèe} - {Q}_{H 2 , sortie}}{{Q}_{H 2 , entrèe}} * 100 \%$$

where:
Q_{H2.entrée} is the molar flow rate of hydrogen on input to the methanation reactor; and
Q_{H2.sortie} is the molar flow rate of hydrogen on output from the methanation reactor.

The deviation from equilibrium is calculated, for example, according to the following equation:

$${Δ}_{eq} = 1 - \frac{{Q}_{H 2 , entrèe} - {Q}_{SNG}^{èquilibre} . {x}_{H 2}}{{Q}_{H 2 , entrèe} - {Q}_{SNG}^{expèrimental} . {x}_{H 2}}$$

where:
Q_{H2.entrée} is the volumetric flow rate of hydrogen on input to the methanation reactor;
Q_{SNG}^{experimental} is the experimental volumetric flow rate of the methanation product called SNG (acronym for “Substitute Natural Gas”), composed of CH₄ and water; and
Q_{SNG}^{équilibre} is the volumetric flow rate of the methanation product calculated at equilibrium using the Aspen HYSIS (commercial name) software system, and x_{H2} is the volume fraction of the hydrogen.

Note that the deviation from equilibrium indicates whether the system is close to conversions obtained at thermodynamic equilibrium. In other words, if the maximum conversion is achieved during the methanation reaction. Therefore, the closer the deviation is to 0, the closer the system is to thermodynamic equilibrium under the operating conditions of the example.

The maximum hydrogen conversion at equilibrium is calculated, for example, according to the following equation:

$$Conversion {H}_{2} ( èquilibre ) = Conversion {H}_{2} * ( 1 + {Δ}_{eq} ) * 100 \%$$

Note that the H₂ conversion at equilibrium is the maximum hydrogen conversion that the system can achieve. Therefore, the closer the conversion obtained experimentally gets to the conversion at equilibrium, the closer the system gets to the maximum conversion that can be obtained under the operating conditions of the example.

Note that, in a similar way, these elements can also be calculated for the methanation of CO. Note that a good quality of fluidisation corresponds to good hydrodynamics of fluidisation and is therefore linked to a high conversion.

The examples of FIG. 8 show the performance of spheres made of a catalytic material during a methanation reaction of the CO₂ performed in a fluidised-bed reactor. In effect, it is noted that, for different fluidisation regimes, i.e. at different gas flow rates, the conversion of hydrogen remains above 96%, which also corresponds to the maintenance of a good quality of fluidisation.

Therefore, the systems of the different examples associated with FIG. 8 achieve a maximum conversion for all the fluidisation regimes implemented in these examples. Such a maximum conversion is highlighted by the very low deviation between:
the conversion of hydrogen obtained experimentally (Conversion H₂), described above in formula 2, and
the conversion calculated at equilibrium (Conversion H₂ (équilibre)), described above in formula 4.

It is noted here that, given an H₂/CO₂ ratio (70/30) lower than the stoichiometric ratio, a condition imposed voluntarily, the conversion of CO₂ is not total. However, the conversion of CO₂ remains stable around 50% under the tested conditions of the examples. This experimental conversion of CO₂ corresponds to the maximum conversion that can be achieved under such test conditions. Therefore, for all the examples associated with FIG. 8, it is noted that the use of spheres made of a catalytic material shows great flexibility in the conditions of use of the catalyst.

### Limitation of the Attrition

The mechanical resilience of the spheres made of a catalyst precursor material has been compared to the mechanical resilience of commercial particles made of a catalyst precursor material during the implementation of a fluidised-bed method favouring attrition phenomena. In the remainder of the description, it is noted that:
The term “spheres” refers to the spheres made of a catalyst precursor material, the subjects of the invention; and
The term “commercial particles” refers to the commercial particles made of a catalyst precursor material.

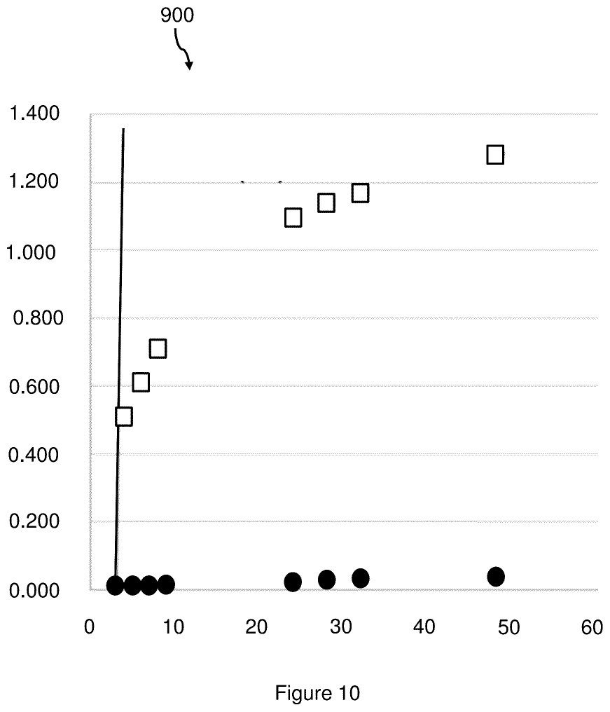

Note that FIGS. 9 and 10 show results obtained during the implementation of a methanation method for two comparative examples, one corresponding to the spheres and the other to the commercial particles. An attrition system is therefore obtained for each example. In the comparative examples of FIGS. 9 and 10:
the spheres made of a catalyst precursor material, prior to the implementation of conditions of attrition, have the following composition: 23.3% NiO, 76.7% Al₂O₃, and a sphericity factor equal to 0.79;
the commercial particles, prior to the implementation of conditions of attrition, have:
a nickel content equal to 47% by mass; and
a sphericity factor corresponding to 0.73.

Note that the implementation conditions of the method for the comparative examples shown in FIGS. 9 and 10 are configured to generate significant mechanical stresses on the two materials, spheres and particles. In particular, the attrition test examples are carried out according to parameters such as the fluidisation temperature, the velocity of an inert gas of fluidisation, and the water vapour content. These parameters are configured to generate mechanical stresses.

For the attrition test examples, the spheres or commercial particles are loaded into a fluidised-bed reactor, then supplied with an inert gas corresponding to air for the fluidisation of the spheres or commercial particles. Note that, in the examples of FIGS. 9 and 10, the spheres and commercial particles are subjected to the following fluidisation conditions:
temperature: 320° C. for the commercial spheres and the spheres;
pressure: atmospheric;
fluidisation gas velocity 10 times higher than the minimum fluidisation velocity;
duration of the tests: 48 hrs.

In the comparative examples shown in FIGS. 9 and 10, the production of fines is evaluated by weighing particles collected using a cyclone coupled to the outlet from the fluidised-bed reactor.

Graph 800, shown in FIG. 9, presents, on the x-axis, the time in hours (h) and, on the y-axis, the rate of attrition by range per gram of the bed and per hour (g/g/h) for two materials tested.

The formula 5 below is used to calculate the rate of attrition indicated in FIG. 9. The rate of attrition is defined by the loss of mass per unit of time, for example, according to the following equation:

$$r = \frac{- 1}{{m}_{b}} \frac{d {m}_{loss , t}}{dt}$$

where:
m_{b} is the mass of the bed; and
M_{loss.t} is the mass lost for a time t.

In these examples, the mass of the fines is determined by weighing, after the end of the attrition method, the fines formed during the implementation of such a method. The initial mass corresponds to the mass of catalyst precursor material loaded into the fluidisation reactor.

Graph 900, shown in FIG. 10, presents, on the x-axis, the time in hours (h) and, on the y-axis, the cumulative mass of the fines as a percentage for two materials tested. The line shown on graph 900 corresponds to the delimitation of an initial step of heating/de-fining performed before the review of the system and by implementing the fluidisation conditions mentioned above for 3 hrs. Note that the heating/de-fining step reproduces conditions implemented, for example, during a mechanical treatment step performed in a fluidised bed.

Note that, in FIGS. 9 and 10, each comparative example corresponds to:
the spheres, associated to the black circles; or
the commercial particles, associated to the white squares.

The comparative examples in FIGS. 9 and 10 show the limitation of the attrition of the spheres, and therefore the production of fines, during the implementation of conditions of attrition. In effect, it is noted that, for a similar duration of the attrition method, the cumulative mass lost for the spheres is less than the cumulative mass lost for the commercial particles. In addition, the instantaneous rate of attrition of the spheres is lower than the instantaneous rate of attrition of the commercial particles.

Through this example, it is deduced that the spheres that are the subjects of the invention have a better mechanical resilience compared to the commercial particles.

In addition, as can be seen in FIG. 9, the rate of attrition is higher during the first twenty hours of the implementation of the attrition method. In effect, during this period, the angular particles are treated mechanically by the fluidised bed, with a more significant generation of fines. This effect is less pronounced towards the end of the implementation of the attrition method.

In addition, this effect of the significant formation of fines at the start of the fluidisation process has also been verified in another example (not shown), for a fluidised-bed methanation reactor initially loaded with approximately 100 kg of spheres made of a catalytic material that are the subjects of the invention.

In this other example, over the first fifty hours of operation, approximately 100 g of fines have been captured at a bag filter placed downstream from the methanation reactor, i.e. 0.1% of the initial load. Next, between these first fifty hours and over 1000 hours of operation, only some ten grams of fines have been collected. During the first hours of operation, the angular parts are eroded slightly until the formation of an almost perfect sphere by mechanical treatment, thereby generating a certain amount of fines. Once this process has finished, the attrition phenomena are almost zero with a weight loss of approximately 0.01% every 1000 hours of operation. Such a result shows the added advantage of implementing a step 202 of mechanically treating the support to improve the sphericity factor prior to the step 102 of incorporating the nickel precursor, preferably in a fluidised bed.

1-24. (canceled)

25. A preparation method for preparing a generally spherical catalyst precursor material for a methanation reaction, comprising:
a formation step for forming a generally spherical support comprising mesoporous alumina (Al₂O₃) or an alumina precursor and having a sphericity factor greater than 0.75, preferably greater than 0.80 and more preferably greater than 0.85:
an incorporation step for incorporating a nickel precursor into the support comprising mesoporous alumina (Al₂O₃) or an alumina precursor by bringing a composition comprising the nickel precursor into contact with the support;
a calcination step for calcining the support incorporating the nickel precursor to at least partially transform the nickel precursor into nickel oxide (NiO) and the alumina precursor into alumina, and subsequently form a solid having a generally spherical shape, the solid being referred to as a “sphere made of a catalyst precursor material for a methanation reaction”; and
a step of mechanically treating the spherical support after the step of forming the support, to increase the sphericity factor of the spherical support.

26. The method according to claim 25, wherein the mechanical treatment step is performed in a fluidised bed by passing a gas in contact with the spherical support.

27. The method according to claim 26, wherein the mechanical treatment step and the calcination step are concurrent and performed in a fluidised bed.

28. The method according to claim 26, wherein during the mechanical treatment step performed in a fluidised bed, the gas in contact with the spherical support is an inert gas.

29. The method according to claim 26, wherein during the mechanical treatment step performed in a fluidised bed the fluidisation rate is at least two times higher than the minimum fluidisation velocity.

30. The method according to claim 26, wherein during the mechanical treatment step performed in a fluidised bed, preferably, the fluidisation rate is at least six times higher than the minimum fluidisation velocity.

31. The method according to claim 26, wherein during the mechanical treatment step performed in a fluidised bed the fluidisation rate is at least ten times higher than the minimum fluidisation velocity.

32. The method according to claim 26, wherein, after the step of mechanical treatment in a fluidised bed, the step of incorporating a nickel precursor is also performed in the fluidised-bed reactor.

33. The method according to claim 25, wherein the mechanical treatment step is performed using a rotating tank configured to generate impacts between the support particles.

34. The method according to claim 25, wherein the generally spherical support comprises a hydrated alumina of boehmite type (formula AlOOH).

35. The method according to claim 25, wherein the incorporation step comprises a step of impregnating the support with a solution comprising the nickel precursor.

36. The method according to claim 25, wherein the step forming the spherical support comprises at least one of:
a granulation step,
an atomisation step,
a step of droplet coagulation.

37. A device for preparing a generally spherical catalyst precursor material for a methanation reaction, comprising:
a means for forming a generally spherical support comprising mesoporous alumina (Al₂O₃) or an alumina precursor and having a sphericity factor greater than 0.75, preferably greater than 0.80 and more preferably greater than 0.85;
a means for incorporating a nickel precursor into the support comprising mesoporous alumina (Al₂O₃) or an alumina precursor, by bringing a composition comprising the nickel precursor (Ni) into contact with the support; and
a means for calcining the support incorporating the nickel precursor, configured to at least partially transform the nickel precursor into nickel oxide (NiO) and the alumina precursor into alumina, and configured to form a solid having a generally spherical shape, this solid being referred to as a “sphere made of a catalyst precursor material for a methanation reaction”,
which device also comprises a means for mechanically treating the spherical support, after the formation of the support, to increase the sphericity factor of the spherical support.

38. Spheres made of a catalyst precursor material for a methanation reaction, obtained by the method (100, 200, 300) according to claim 25, wherein they comprise nickel oxide (NiO) and mesoporous alumina (Al₂O₃), the respective proportions of which are, relative to the total mass of these two compounds:
NiO: 1 to 50% by mass; and
Al₂O₃: 50 to 99% by mass.

39. The spheres made of a catalyst precursor material according to claim 38, which have a monomodal granulometry with a median diameter of between 100 and 1000 μm, preferably between 200 and 800 μm, and more preferably between 250 and 350 μm.

40. The spheres made of a catalyst precursor material according to claim 38, wherein the alumina (Al₂O₃) has a gamma or delta structure and/or wherein the alumina (Al₂O₃) has a mesoporosity corresponding to a median diameter of the pores, determined by Hg intrusion porosimetry, of between 3 and 50 nm, and preferably between 5 and 25 nm.

41. The spheres made of a catalyst precursor material according to claim 38, which have a specific surface area of between 50 and 300 m²/g, and preferably between 100 and 250 m²/g.

42. A methanation method (500), comprising:
a step of activating, at least partially, spheres made of a catalyst precursor material according to claim 38 into spheres made of a catalytic material; and
a step of passing a gas comprising hydrogen (H₂) and at least carbon monoxide (CO)
and/or carbon dioxide (CO₂) in contact with spheres made of a catalytic material.

43. A method according to claim 42, which comprises, prior to the gas passage step, a step of constituting the gas comprising at least one of the following steps:
pyrolysis of hydrocarbon materials;
pyro-gasification of hydrocarbon materials;
gasification of hydrocarbon materials;
co-electrolysis of CO₂/H₂O;
water-gas reaction;
reverse water-gas reaction;
a step of producing a gas rich in hydrogen;
a step of producing a gas rich in CO₂; and
a step of introducing vapour to the gas.

44. A methanation device, comprising:
a layer of spheres made of a catalytic material, obtained by activating spheres made of a catalyst precursor material according to claim 38; and
a means for passing a gas comprising hydrogen (H₂) and at least carbon monoxide (CO) and/or carbon dioxide (CO₂) in contact with spheres made of a catalytic material.
